(19) United States
(12) Patent Application Publication
(10) Pub. No.: US 2014/0006721 A1
(43) Pub. Date: Jan. 2, 2014

(54) INFORMATION PROCESSING APPARATUS AND CACHE CONTROLLING METHOD

(71) Applicant: FUJITSU LIMITED, Kawasaki-shi (JP)

(72) Inventors: Yuuji KONNO, Yokohama (JP); Yasuhiro Kuroda, Kawasaki (JP)

(73) Assignee: FUJITSU LIMITED, Kawasaki-shi (JP)

(21) Appl. No.: 14/020,120

(22) Filed: Sep. 6, 2013

Related U.S. Application Data
(63) Continuation of application No. PCT/JP2011/055488, filed on Mar. 9, 2011.

(51) Int. Cl. G06F 12/08

(52) U.S. Cl. CPC G06F 12/0891
USPC 711/144

(57) ABSTRACT

When an uncorrectable error (UE) occurs in data read out from a second tag memory corresponding to a first tag memory of an arithmetic processing unit, a system controller issues a notification of WAY information of the second tag memory in which the UE has occurred to the arithmetic processing unit. The arithmetic processing unit degenerates a WAY of the corresponding first tag memory based on the received WAY information and issues a notification of completion of the degeneration process to the system controller. The system controller degenerates the WAY of the second tag memory in which the UE has occurred and re-issues a request relating to the UE after a notification that the degeneration process of the first tag memory is completed is received from the arithmetic processing unit.

### CROSS-REFERENCE TO RELATED APPLICATION

This application is a continuation application of International Application PCT/JP2011/055488 filed on Mar. 9, 2011 and designated the U.S., the entire contents of which are incorporated herein by reference.

### FIELD

The present application relates to an information processing apparatus and a cache controlling method.

### BACKGROUND ART

In recent years, in order to achieve increase of the speed of processing or improvement in fault tolerance, an symmetric multi processor (SMP) server system that uses a symmetric multiprocessing method is sometimes used.

The SMP is a multiprocessor method wherein a plurality of central processing units (CPUs) share processing in the equivalent position and has a function for synchronizing the CPU cache or a function for managing various resources used for processing.

The SMP server system is configured not only from a plurality of CPUs or a system controller (hereinafter referred to as SC) and a memory such as a random access memory (RAM) but also from an operation management unit in which firmware for controlling the system is incorporated and so forth.

In such an SMP server system as just described, in order to improve the processing speed, a copy (TAG_CP) of cache tag (TAG) data of the CPUs is sometimes stored in the SC. In this case, in response to an inquiry from each CPU, the TAG_CP is referred to and a response is returned by the SC provided at the preceding stage to the target CPU. Consequently, high-speed cache access by a snoop method is implemented and increase of the speed of a synchronization process of a cache memory (hereinafter referred to as CM) of the CPU is implemented.

It is to be noted that the snoop method is one kind of an algorithm of a cache coherency, and information of an updating state is exchanged with a different cache so that it can be grasped in what cache the latest data is stored and the latest data can be acquired.

Further, in recent years, in the CM of the CPU, in accordance with increase of the number of cache lines, a set associative configuration that is a data storage structure by a plurality of WAYs is adopted.

In the set associative configuration, in the CM of the CPU, a plurality of WAYs are provided for each of cache lines and data is stored in each WAY.

Cache tag data is stored in a TAG memory in the inside of the CPU and a TAG_CP memory in the inside of the SC and is managed by an address for which part of a physical address of the memory, which is called index, is used. The cache tag data is used, in response to a request from the CPU, to narrow down to one WAY from one cache line in the CM specified by the index to acquire desired data from the CM.

It is to be noted that, as the CM, TAG memory and TAG_CP memory, a RAM such as an static RAM (SRAM) is applicable.

In the SMP server system described above, if a fault of the CPU, CM, TAG memory, TAG_CP memory or the like is detected, then a degeneration process for cutting away a portion at which a fault occurs from the system is performed by the operation management unit. By the degeneration process, operation can be continued without interruption of operation of the system and enhancement of the resistance against a fault is implemented.

Particularly, when a fault of the TAG_CP memory or the like occurs in a large-scale SMP server system used in a mission-critical field, even if a performance of the system degrades, it is desirable to cut away a suspect location to continue operation. Therefore, in a conventional SMP server system, a mechanism is incorporated in which, when a fixed 1-bit fault of the TAG memory in the CPU or the TAG_CP memory in the SC occurs, a WAY at a suspect location is dynamically degenerated and the fault location is cut away without stopping the operation.

It is to be noted that, in a 1-bit fault, an error can be corrected by an error correction code (Error Correcting Code; hereinafter referred to as ECC) included in the cache tag data. The 1-bit fault is hereinafter referred to as correctable error (CE).

Operation of a degeneration process of the system when a CE occurs in the TAG_CP memory in the SC is described below.

FIG. 10 is a view illustrating a degeneration range when a CE occurs in a TAG_CP memory 420-2 in an SC 400, and FIG. 11 is a flow chart illustrating a degeneration process when a CE occurs in the TAG_CP memory 420-2 in the SC 400.

As exemplified in FIG. 10, the SMP server system includes a system board (hereinafter referred to as SB) 200 and an operation management unit 600.

The SB 200 includes CPUs 300-1 to 300-4, an SC 400 and a memory 500. It is to be noted that, where the CPUs 300-1 to 300-4 are not to be distinguished from each other in the following description, each CPU is referred to simply as CPU 300.

The CPUs 300-1 to 300-4 include CMs 310-1 to 310-4 and TAG memories 320-1 to 320-4, respectively. It is to be noted that a numeral on the right side of a hyphen “-” in the reference characters of the CMs 310-1 to 310-4 and the TAG memories 320-1 to 320-4 indicates that the CMs 310-1 to 310-4 and the TAG memories 320-1 to 320-4 are provided in the CPUs 300-1 to 300-4 having the corresponding numerals, respectively.

The SC 400 includes TAG_CP memories 420-1 to 420-4 corresponding to the TAG memories 320-1 to 320-4. It is to be noted that, where the TAG_CP memories 420-1 to 420-4 are not to be distinguished from each other in the following description, each TAG_CP memory is referred to simply as TAG_CP memory 420.

If a CE occurs in the TAG_CP memory 420-2 in the SC 400 during operation of the system as depicted in FIGS. 10 and 11 and is detected by the SC 400 (step S101), then a notification of information of a suspect location is issued from the SC 400 to the CPU 300-2 corresponding to the TAG_CP memory 420 in which the CE has occurred (step S102). It is to be noted that this information includes an index of the suspect location corrected based on an ECC and a WAY number.

In the CPU 300-2, data of the WAY in the TAG memory 320-2 corresponding to the provided suspect location is discharged into the memory and a degeneration process of the WAY is performed (step S103). Then, by the CPU 300-2, a notification of degeneration process completion is issued to the SC 400 (step S104).

In the SC 400 that receives the degeneration process completion notification, a degeneration process is performed for the WAY of the suspect location (step S105). Then, by the SC 400, an error notification including a WAY number of the CPU 300-2 which has performed the degeneration process is issued to the operation management unit 600 (step S106), and failure information is recorded into controlling information of the operation management unit 600 (step S107). Thereafter, operation is continued in the SMP server system (step S108).

As described above, part (WAY) of the TAG memory 320-2 in the CPU 300-2 and part (WAY) of the TAG_CP memory 420-2 in the SC 400 are degenerated (refer to “degeneration range” in FIG. 10). Consequently, although some performance degradation occurs in the system, since the degeneration process is dynamically performed, stopping of the operation can be avoided.

It is to be noted that the failure information recorded into the controlling information of the operation management unit 600 at step S107 is used to degenerate the WAY of the suspect location again, for example, when the degeneration state in the CPU and the SC is reset by restarting or the like of an operating system (OS) during execution by the SMP server system.

Incidentally, when a failure in which an error is not correctable occurs in the TAG_CP memory in the SC, the SC is unable to perform correction of the error using an ECC and the cache coherency can be unsustainable. Therefore, in the conventional SMP server system, a mechanism is incorporated in which, when a failure in which an error is not correctable occurs in the TAG_CP memory in the SC, the CPU corresponding to the suspect location is degenerated to temporarily stop operation and cut away the failure location.

It is to be noted that a failure in which an error is not correctable signifies a failure in which an error is not correctable even if the ECC included in the cache tag is used, and is, for example, a failure of a region of two or more bits. A failure of a region of two or more bits (multi-bit failure) is hereinafter referred to as uncorrectable error (UE).

Operation of a degeneration process of the system when a CE occurs in the TAG_CP in the SC is described below.

FIG. 12 is a view illustrating a degeneration range when a UE occurs in the TAG_CP memory 420-2 in the SC 400 in the SB 200 and the operation management unit 600 that have a configuration similar to that depicted in FIG. 10. Further, FIG. 13 is a flow chart illustrating a degeneration process when a UE occurs in the TAG_CP memory 420-2 in the SC 400.

If a UE occurs in the TAG_CP memory 420-2 in the SC 400 as depicted in FIGS. 12 and 13 and is detected by the SC 400 during operation of the system (step S111), then a notification that a UE has occurred is issued as an interrupt from the SC 400 to the operation management unit 600 (step S112).

In the operation management unit 600, information indicating the CPU 300-2 and a WAY number corresponding to the suspect location are recorded as failure information into controlling information of the operation management unit 600 based on the interrupt notification (step S113). Then, an OS being executed by the SMP server system is restarted by the operation management unit 600 (step S114).

After the OS is restarted, the failure information of the controlling information is read in by the operation management unit 600 (step S115), and a starting process is not performed for the CPU 300-2 recorded in the failure information while a starting process is performed only for the other normal CPUs 300-1, 300-3 and 300-4. In other words, by the operation management unit 600, the OS is started in a state in which the degeneration process is performed for the CPU 300-2 corresponding to the suspect location and the TAG_CP memory 420-2 corresponding to the suspect location (step S116, refer to “degeneration range” in FIG. 12). Thereafter, operation is restarted in the SMP server system (step S117).

In this manner, when a UE occurs in the TAG_CP memory 420 in the SC 400, a method of stopping operation of the SMP server system and then restarting operation after all components (for example, one entire CPU 300) including the suspect location are degenerated is adopted.

It is to be noted that a technology is known which makes it possible to continue, in a multiprocessor system including a plurality of CPUs individually incorporating a cache memory, operation even when an uncorrectable failure occurs in a tag index result indexed from a tag memory included in a memory control/coherency controlling apparatus.

In particular, when the memory control/coherency controlling apparatus detects an uncorrectable failure from a tag index result indexed from a tag memory, an instruction is issued to each CPU to extract all data having the possibility that the data may relate to the tag index result in which the uncorrectable failure is detected to a main storage apparatus. Consequently, the coherency of the data can be secured.

It is to be noted that all data having the possibility that the data may relate to the tag index result in which the uncorrectable failure is detected signifies all of those data stored in the cache memory whose lower address coincides with a lower address used upon tag indexing.
Patent Document 1: Japanese Laid-Open Patent Publication No. 2008-52550

Conventionally, the occurrence frequency of an uncorrectable error (UE) in a TAG_CP memory is low. Therefore, as exemplified in FIGS. 12 and 13, when a UE occurs, operation for degenerating a CPU corresponding to a suspect location and a TAG_CP memory in a SC of the suspect location is performed.

However, in the method described just above for a case in which a UE occurs, there is a problem that a time period within which the operation stops appears and the availability of the SMP server system degrades.

Further, in recent years, the CM capacity is increasing by increasing the degree of integration in an large scale integration (LSI). Further, the total CM capacity in the SMP server system is increasing in accordance with increase of the number of CPUs to be incorporated in the SMP server system. By such increase of the CM capacity in the SMP server system as described above, the probability that a UE may occur is high in comparison with the former configuration.

In this manner, in the present situation in which the occurrence probability of a UE is high, also there is a problem that a scene (frequency) in which the availability of the SMP server system degrades increases.

Further, in the technology that uses the memory control/coherency controlling apparatus described above, although the coherency of data can be secured also when an uncorrectable error is detected, it has problems described in (i) and (ii) given below.

(i) When an uncorrectable error occurs in a tag unit in the memory control/coherency controlling apparatus and part of the tag unit is degenerated, since the CPU does not know that part of the tag unit has been degenerated, there is the possibility that such a request as to re-use the degenerated part of the tag unit may be transmitted from the CPU. When such a request as just described is transmitted, the memory control/coherency controlling apparatus returns a response that use of the tag unit in accordance with the request is impossible or another response that a cache is used without being registered into the tag unit to the CPU.

In such a case as just described, there is a problem that the performance of the system degrades in situations described in (i-1) to (i-3) given below.

(i-1) When reception of the response described above is not permitted, namely, when a process for the response described above is not defined and the CPU is not ready for the response, there is the possibility that the CPU may fall into a disabled state.

(i-2) Further, even when the response described above is permitted and operation is performed, depending upon a process to be executed by the CPU, there is the possibility that such a request as to re-use degenerated part of the tag unit may be repetitively outputted to the memory control/coherency controlling apparatus. In such a situation as just described, since the request and the response described above are repetitively performed between the CPU and the memory control/coherency controlling apparatus, performance degradation of the system is caused.

(i-3) Or, it is considered that the memory control/coherency controlling apparatus issues a discharging instruction of data of a different WAY of a lower address same as that used upon tag indexing to the CPU that is a source of the request transmission before a response to the request is returned. In this case, after the discharge by the CPU is completed, the memory control/coherency controlling apparatus performs such operation as to return a response to the original request to the CPU that is a source of the request. Consequently, while the coherency of data can be maintained, the process for the response described above is performed by the CPU and performance degradation of the system is caused.

(ii) Further, the memory control/coherency controlling apparatus includes an entry use inhibition flag indicating a degeneration state of an entry in the tag memory. However, when a failure occurs in an address line system of the tag memory, there is the possibility that the entry use inhibition flag itself may be read out incorrectly.

In particular, when a failure occurs in an address line system of the tag memory, access to a cell of the tag memory may be performed incorrectly and the entry use inhibition flag itself may be read out incorrectly. Accordingly, even if information indicating degeneration is set in the entry use inhibition flag, actually it does not seem to the system that the degeneration has been performed, and there is the possibility that occurrence of a UE may be detected every time retry is performed and then the system may fall into a processing-disabled state.

It is to be noted that, while a method may seem applicable in which an entry use inhibition flag is provided not in a tag memory but, for example, in a latch for each of entries, this method is difficult from the amount of resources.

### SUMMARY

According to an aspect of the embodiments, an information processing apparatus includes an arithmetic processing unit including a cache memory and a first tag memory; and a system controller that performs communication control between the arithmetic processing unit and a different processing apparatus; wherein the system controller includes a command controlling unit that retains a request received from the arithmetic processing unit and re-issues the request when the request is not processed in a requesting destination; a second tag memory that retains replicated data of data stored in the first tag memory; and a request controlling unit that issues, when an uncorrectable error (UE) occurs in data read out from the second tag memory, a notification of WAY information of the second tag memory in which the UE has occurred to the arithmetic processing unit, wherein the arithmetic processing unit degenerates, when the notification of the occurrence of the UE is received from the request controlling unit, a WAY of the first tag memory corresponding to the WAY of the second tag memory in which the UE has occurred and then issues a notification that a degeneration process of the WAY of the first tag memory is completed to the request controlling unit; and the request controlling unit degenerates, when the UE occurs, the WAY of the second tag memory in which the UE has occurred, and receives the notification that the degeneration process of the first tag memory is completed from the arithmetic processing unit and then issues an instruction for causing the command controlling unit to re-issue a request relating to the UE.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a view depicting a configuration of an information processing system as an example of a first embodiment;

FIG. 2 is a view depicting a configuration of a system controller as an example of the first embodiment;

FIG. 3 is a view illustrating a degeneration range when a UE occurs in a cache tag memory in the system controller as an example of the first embodiment;

FIG. 4 is a flow chart illustrating a degeneration process when a UE occurs in the cache tag memory in the system controller as an example of the first embodiment;

FIG. 5 is a view depicting a configuration of an information processing system as an example of a second embodiment;

FIG. 6 is a view illustrating an address map of a memory as an example of the second embodiment;

FIG. 7 is a view depicting a configuration of a TAG_CP memory as an example of the second embodiment;

FIG. 8 is a view depicting a configuration of a system controller as an example of the second embodiment;

FIG. 9 is a flow chart illustrating a degeneration process when a CE or a UE occurs in a cache tag memory in the system controller as an example of the second embodiment;

FIG. 10 is a view illustrating a degeneration range when a CE occurs in a TAG_CP memory in the system controller;

FIG. 11 is a flowchart illustrating a degeneration process when a CE occurs in the TAG_CP memory in the system controller;

FIG. 12 is a view depicting a degeneration range when a CE occurs in the TAG_CP memory in the system controller; and

FIG. 13 is a flowchart illustrating a degeneration process when a CE occurs in the TAG_CP memory in the system controller.

### DESCRIPTION OF THE EMBODIMENT

In the following, embodiments of the present invention are described with reference to the drawings.

### [1] First Embodiment

### [1-1] Configuration of the First Embodiment

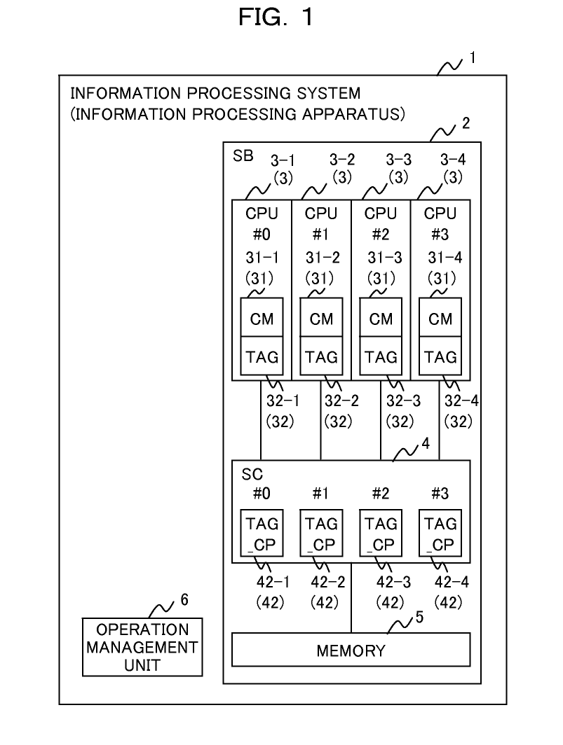

FIG. 1 is a view depicting a configuration of an information processing system 1 as an example of the first embodiment.

As depicted in FIG. 1, the information processing system (information processing apparatus) 1 includes an SB 2 and an operation management unit 6.

The information processing system 1 is, for example, an SMP system server.

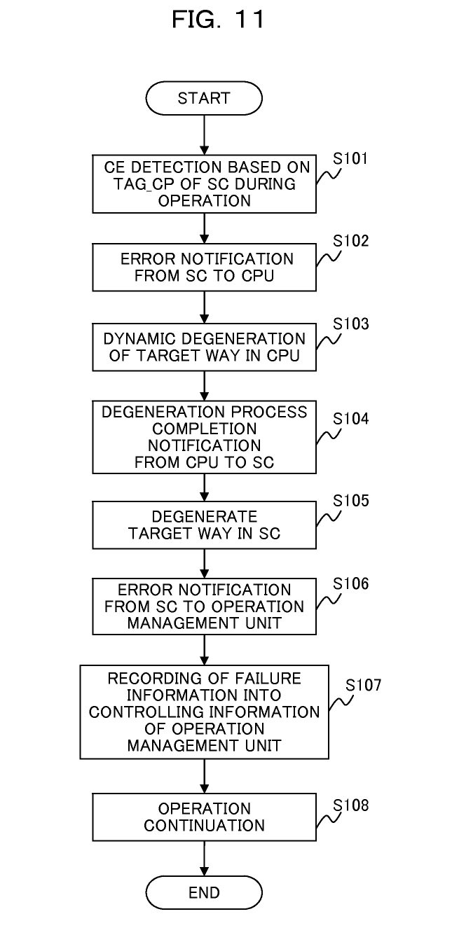

The information processing system 1 in the first embodiment can continue, when a CE occurs in a TAG_CP memory 42 in a SC 4, operation by the method described above and depicted in FIG. 11. It is to be noted that detailed description of operation of the information processing system 1 when a CE occurs is omitted in the description of the first embodiment.

When a UE occurs in a TAG_CP memory 42 in the SC 4, the information processing system 1 in the first embodiment dynamically degenerates a WAY of the TAG_CP memory 42 in which the UE has occurred and a WAY of a TAG_CP memory 32 of a CPU 3 corresponding to the WAY as described above such that operation can be continued.

The SB 2 includes at least one (four in the first embodiment) CPUs 3-1 to 3-4, an SC 4 and a memory 5 such as a RAM. It is to be noted that, when the CPUs 3-1 to 3-4 are not to be distinguished from each other in the following description, each CPU is referred to simply as CPU 3.

The CPUs 3-1 to 3-4 are arithmetic processing units connected to the SC 4 and perform various controls and arithmetic operations in the information processing system 1, and develop a program stored, for example, in a storage unit (not illustrated) into the memory 5 and execute the program to implement various functions.

The CPUs 3-1 to 3-4 include CMs 31-1 to 31-4 and TAG memories (first tag memories) 32-1 to 32-4, respectively. When the CMs 31-1 to 31-4 are not to be distinguished from each other in the following description, each CM is referred to simply as CM 31. Further, when the TAG memories 32-1 to 32-4 are not to be distinguished from each other, each TAG memory is referred to simply as TAG memory 32.

It is to be noted that a numeral on the right side of the hyphen “-” in reference characters of the CMs 31-1 to 31-4 and the TAG memories 32-1 32-4 indicates that the CM 31 and the TAG memory 32 are provided in the CPUs 3-1 to 3-4 having corresponding numerals.

Each CM 31 stores data to be transferred between the CPU 3 and the memory 5 therein. It is to be noted that, in the first embodiment, a case is exemplified in which an n-WAY set associative method is adopted by the CM 31.

Each TAG memory 32 stores cache tag data that is reference information of data retained by the CM 31 therein.

If a notification that a CE has occurred (CE notification request) or another notification that a UE has occurred (UE notification request) is received from the SC 4, then the TAG memory 32 dynamically degenerates a WAY of the TAG memory 32 corresponding to the WAY of the TAG_CP memory 42 in which the CE or UE has occurred. Then, the CPU 3 issues, after degeneration of the WAY, a notification that a degeneration process of the WAY of the TAG memory 32 is completed.

It is to be noted that cache tag data of the TAG_CP memory 42 in which a CE or a UE has occurred (is detected) is hereinafter referred to sometimes as suspect location.

The SC (system controller) 4 is an LSI that controls access between the CPU 3 and the memory 5 and performs communication control between the CPU 3 and a different CPU 3 or an external processing apparatus of the SB 2. It is to be noted that, in the first embodiment, a case is exemplified in which a snoop method is adopted as an algorithm of the cache coherency by the CPU 3 and the SC 4.

Further, the SC 4 in the first embodiment includes TAG_CP memories (second tag memories) 42-1 to 42-4 corresponding to the TAG memories 32-1 to 32-4.

The TAG_CP memories 42-1 to 42-4 retain copy data of data stored in the corresponding TAG memories 32-1 to 32-4. When the TAG_CP memories 42-1 to 42-4 are not to be distinguished from each other in the following description, each TAG_CP memory is referred to simply as TAG_CP memory 42.

It is to be noted that, as the CM 31, TAG memory 32 and TAG_CP memory 42, for example, a RAM such as an SRAM is applicable.

The SC 4 stores copy data of cache tag data of the CPU 3 into the TAG_CP memory 42 to perform a predetermined process in response to a request by referring to the TAG_CP memory 42 in response to a request such as an access request from each CPU 3 to the memory 5 and then returns a response to the CPU 3 that is a source of the request. Consequently, high-speed cache access by the snoop method is implemented and increase of the speed of a synchronization process of the CM 31 of the CPU 3 is implemented.

Further, if an uncorrectable error (UE) occurs in the TAG_CP memory 42 during operation of the information processing system 1, then the SC 4 reserves a process relating to a request (hereinafter referred to as UE detection request) in which a UE has been detected from among requests from the CPU 3.

Then, the SC 4 outputs a UE notification request including error information to the CPU 3 corresponding to the TAG_CP memory 42 in which the UE has been detected. It is to be noted that the error information includes WAY information (for example, a number of a WAY and so forth) corresponding to a suspect location. After the UE notification request is received, the CPU 3 dynamically degenerates the WAY of the TAG memory 32 based on the error information and issues, after degeneration of the WAY, a degeneration process completion notification that a degeneration process is completed to the SC 4.

Further, the SC 4 degenerates the WAY of the TAG_CP memory 42 in which the UE has occurred.

Further, the SC 4 receives the degeneration process completion notification from the CPU 3 and restarts a process relating to the UE occurrence request after the degeneration process of the WAY of the TAG_CP memory 42 is completed.

Further, the SC 4 issues an interrupt notification of error information relating to the CE or the UE to the operation management unit 6.

A detailed configuration of the SC 4 is hereinafter described.

The memory 5 is a storage region for temporarily storing various data or a program therein, and temporarily stores and develops the data or the program therein so as to be used when the CPU 3 executes the program. It is to be noted that the memory 5 in the first embodiment can be accessed from all of the CPUs 3-1 to 3-4 and is shared and used by the CPUs 3-1 to 3-4.

In the operation management unit 6, firmware for controlling the information processing system 1 is incorporated and information relating to the WAY degenerated by the CPU 3 and the SC 4 is stored as failure information based on the interrupt notification of the error information relating to the CE or the UE from the SC 4. It is to be noted that the information relating to the degenerated WAY includes information of the CPU 3 corresponding to the suspect location (such as, for example, a number of the CPU and so forth) and WAY information.

Further, when the degeneration state in the CPU 3 and the SC 4 is reset, for example, in accordance with restarting of the OS during execution in the information processing system 1 or the like, the operation management unit 6 re-degenerates the WAY corresponding to the suspect location based on the failure information. It is to be noted that a service processor may be applied as the operation management unit 6.

It is to be noted that the information processing system 1 can include a storage unit (not depicted) such as, for example, a hard disk drive (HDD) or a solid state drive (SSD). The storage unit can be configured for access thereto from each CPU 3 through the SC 4.

### [1-2] Configuration of the System Controller in the First Embodiment

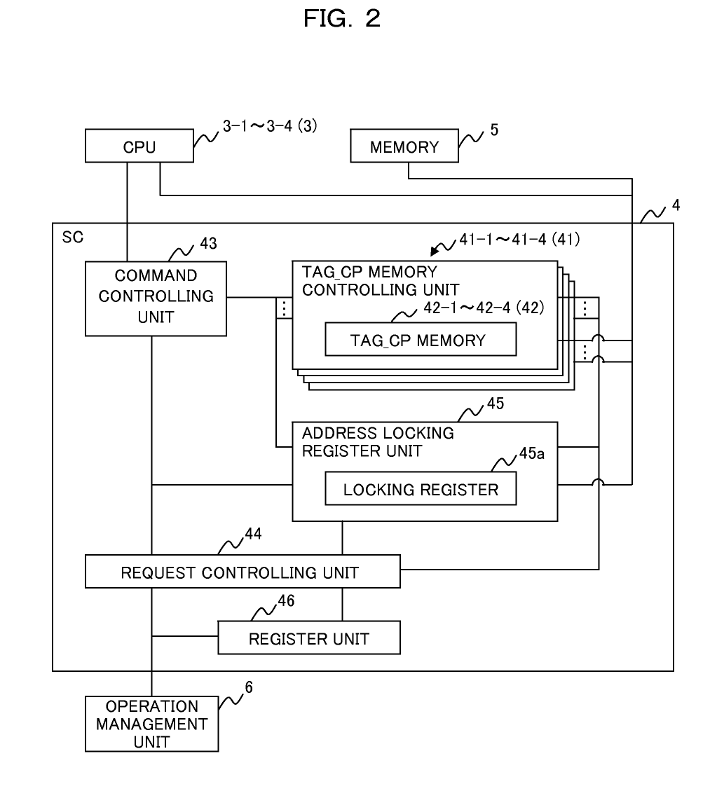

FIG. 2 is a view depicting a configuration of the SC 4 as an example of the first embodiment.

As depicted in FIG. 2, the SC 4 includes a plurality of (in the first embodiment, four) TAG_CP memory controlling units 41-1 to 41-4, a command controlling unit 43, a request controlling unit 44, an address locking register unit 45 and a register unit 46.

The command controlling unit 43 retains a request (command) received from the CPU 3 and performs control for transferring the request to the TAG_CP memory controlling units 41-1 to 41-4 and the address locking register unit 45.

Further, the command controlling unit 43 retains the request received from the CPU 3 until a process is completed in the SC 4. In particular, the command controlling unit 43 retains the request when the request is being processed in a TAG_CP memory controlling unit 41 that is a transmission destination of the request or when the request is not processed.

Further, in the first embodiment, the command controlling unit 43 re-issues the retained request when the request received from the CPU 3 is not processed in the TAG_CP memory controlling unit 41 that is a transmission destination.

It is to be noted that, if the process in the TAG_CP memory controlling unit 41 is completed, then the command controlling unit 43 deletes the request from a queue 43a.

The TAG_CP memory controlling units 41-1 to 41-4 are provided corresponding to the TAG_CP memories 42-1 to 42-4, respectively, and execute a process relating to a request transferred thereto from the command controlling unit 43. It is to be noted that, when the TAG_CP memory controlling units 41-1 to 41-4 are not to be distinguished from each other in the following description, each TAG_CP memory controlling unit is referred to simply as TAG_CP memory controlling unit 41.

In particular, the TAG_CP memory controlling unit 41 extracts an entry address (hereinafter referred to as registration address) for specifying an index and a WAY for specifying a cache line from an actual address (physical address (PA)) of the memory 5 included in the request transferred from the command controlling unit 43. Then, the TAG_CP memory controlling unit 41 searches cache tag data corresponding to the extracted index and registration address from within the corresponding one of the TAG_CP memories 42-1 to 42-4.

It is to be noted that, when the cache tag data relating to the request hits or mishits in the TAG_CP memory 42 in the search, the contents of a later process are determined in response to the contents of the request and the status of the cache tag data. Since the determination of the contents of the process can be implemented by various known methods, detailed description of this is omitted here.

Further, when a CE or a UE is detected in the TAG_CP memory 42, the TAG_CP memory controlling unit 41 issues a notification (TAG_CP error notification) of a suspect location to the request controlling unit 44.

When a CE or a UE occurs in data read out from the TAG_CP memory 42, the request controlling unit 44 issues a notification of WAY information of the TAG_CP memory 42 in which the CE or UE has occurred to the CPU 3.

In particular, if a CE or a UE is detected in the TAG_CP memory 42 and a TAG_CP error notification is received from the TAG_CP memory 42, then the request controlling unit 44 issues a CE notification request or a UE notification request including the index and the WAY information of the suspect location. The CPU 3 to which the notification request relating to the CE or the UE is issued performs the degeneration process for the WAY of the TAG memory 32 corresponding to the WAY of the TAG_CP memory 42 in which the CE or UE has occurred based on the request.

Further, if a TAG_CP error notification that a UE has been detected is received from the TAG_CP memory 42, then the request controlling unit 44 issues a notification of a reservation instruction of the UE detection request to the command controlling unit 43. When the notification of the reservation instruction is received from the request controlling unit 44, the command controlling unit 43 retains the UE detection request as a reservation state.

Further, when a CE or a UE occurs, the request controlling unit 44 degenerates the WAY of the TAG_CP memory 42 in which the CE or UE has occurred. Further, when a UE occurs, the request controlling unit 44 receives a degeneration process completion notification of the TAG memory 32 from the CPU 3 and then issues an instruction for causing the command controlling unit 43 to re-issue the UE detection request.

In particular, if the TAG_CP error notification is received from the TAG_CP memory 42, then the request controlling unit 44 performs degeneration setting of the WAY of the TAG_CP memory 42 in which the CE or UE has been detected to the register unit 46.

Further, when a UE occurs, if the degeneration process completion notification is received from the CPU 3, then the request controlling unit 44 issues a notification of an instruction to restart (re-issue) the process of the UE detection request to the command controlling unit 43. When the notification of the instruction to restart the process of the UE detection request is received from the request controlling unit 44, the command controlling unit 43 cancels the reservation state of the UE detection request to restart the process of the request (re-issue the request).

Further, the request controlling unit 44 degenerates the WAY of the TAG_CP memory 42 in which the CE or UE has occurred and then issues an interrupt notification of error information relating to the CE or UE to the operation management unit 6. The operation management unit 6 receives the interrupt notification and retains the information relating to the degenerated WAY as failure information into the controlling information managed by the operation management unit 6 based on the error information received from the request controlling unit 44. It is to be noted that the failure information includes the information of the CPU 3 corresponding to the suspect location and the WAY information.

Further, when the OS during execution by the information processing system 1 is restarted, the operation management unit 6 degenerates the WAY of the TAG memory 32 and the TAG_CP memory 42 based on the retained failure information.

It is to be noted that the request controlling unit 44 may include or may exclude the information relating to the degenerated WAY in the error information relating to the CE or the UE to be transmitted as an interrupt notification to the operation management unit 6. When the request controlling unit 44 does not include the information relating to the degenerated WAY in the error information, if the interrupt notification of the error information from the request controlling unit 44 is received, then the operation management unit 6 may acquire and retain the information of the CPU 3 corresponding to the suspect location and the WAY information from the register unit 46.

The register unit 46 retains configuration information indicating available WAYs of the TAG_CP memories 42-1 to 42-4.

The configuration information includes a valid or invalid state for each of the WAYs of the TAG_CP memories 42-1 to 42-4, and the valid or invalid state is set by the register unit 46 in response to a setting changing request from the request controlling unit 44.

The valid or invalid state can be represented, for example, by a degeneration flag using a bit of “0” indicating a valid state or a bit of “1” indicating an invalid state.

In other words, the register unit 46 retains the degeneration flags indicating degeneration of the WAYs of the TAG_CP memories 42-1 to 42-4.

In particular, the request controlling unit 44 sets the degeneration flag relating to the WAY of the TAG_CP memory 42 in which a CE or a UE has occurred to the register unit 46 to degenerate the WAY.

It is to be noted that, though not depicted, also the CPUs 3-1 to 3-4 individually include a register unit for retaining configuration information of the WAYs of available TAG memories 32-1 to 32-4.

Accordingly, similarly to the degeneration process by the request controlling unit 44, also the degeneration process of the WAY of the TAG memory 32 by the CPU 3 is performed by setting the degeneration flag relating to the WAY of the corresponding TAG memory 32 to the register unit by the CPU 3.

The address locking register unit 45 includes a locking register 45a and retains the address information in the request during processing in the SC 4 into the locking register 45a.

In particular, the address locking register unit 45 extracts all address (full address) and an index from an actual address in the request transferred from the command controlling unit 43 and retains the extracted full address, namely, the full address relating to the request during processing in the SC 4, into the locking register 45a.

Further, when the full address in the actual address in a later request coincide with the full address in the actual address in the request retained by the locking register 45a, the address locking register unit 45 issues a notification that the full address relating to the later request is in a busy state (full address busy) to the command controlling unit 43. When the notification of the full address busy is received, the command controlling unit 43 transfers the later request to the TAG_CP memory controlling unit 41 and the address locking register unit 45 again and re-issues (retries) the later request.

In this manner, the address locking register unit 45 includes a guarding (locking) function for cancelling and retrying a process relating to a later request transferred from the command controlling unit 43 to guard (lock) so that the later request does not compete with the request during processing.

Further, when the process relating to the request during processing in the SC 4 is completed, the address locking register unit 45 deletes the address information relating to the request from the locking register 45a and cancels the locking of the request.

Further, in addition to the process described above, when a UE occurs, the address locking register unit 45 in the first embodiment retains the full address of the suspect location in the UE detection request into the locking register 45a until the degeneration process of the suspect location in the CPU 3 and the SC 4 is completed. Then, if the full address in the actual address in a later request coincides with the full address of the suspect location retained by the locking register 45a, then the address locking register unit 45 issues a notification of the full address busy of the later request to the command controlling unit 43.

In particular, the address locking register unit 45 inhibits access by a different request to the TAG_CP memory 42 in which the UE has occurred until the degeneration process completion notification of the TAG memory 32 from the CPU 3 is received and the WAY of the TAG_CP memory 42 in which the UE has occurred is degenerated by the request controlling unit 44.

In particular, when a UE is detected based on the UE detection request, the address locking register unit 45 in the first embodiment retains and locks the address information in the UE detection request into the locking register 45a and then cancels the locking of the request when the degeneration process completion notification from the CPU 3 is received.

Consequently, the suspect location can be guarded so that the full address in the UE detection request is not referred to by a different request.

It is to be noted that, when the address of the UE detection request is retained by the locking register 45a, the address locking register unit 45 can guard also the region of the index same as that of the suspect location when the indexes coincide with each other while the full addresses do not coincide with each other. Consequently, when the degeneration process after the UE occurrence is being performed, reference to the region of the index same as that of the suspect location of the TAG_CP memory 42 by the later request can be suppressed. Therefore, it is preferable to configure the address locking register unit 45 such that the bit width in address comparison can be varied.

In this manner, by the guarding function, the address locking register unit 45 in the first embodiment can guard a process relating to a later request so that the later request does not compete with the request during processing and can guard the suspect location when a UE occurs.

### [1-3] Operation Upon Occurrence of a UE by the Information Processing System of the First Embodiment

Now, a degeneration process when a UE occurs in a TAG_CP memory 42 of the SC 4 in the information processing system 1 configured in such a manner as described above is described.

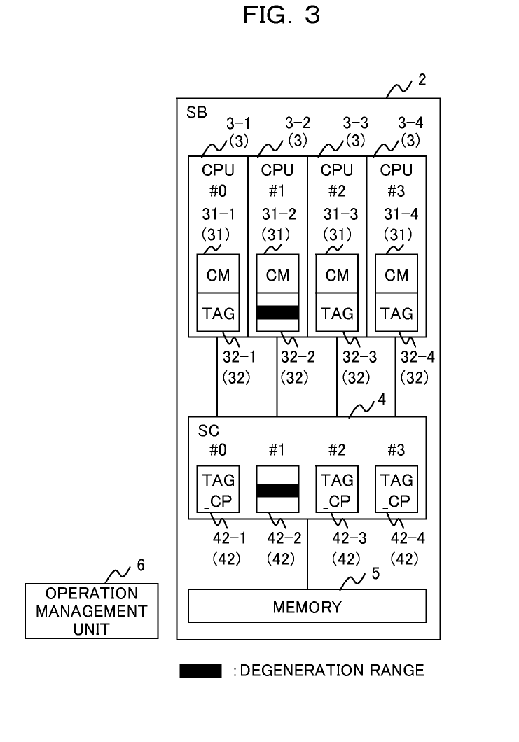

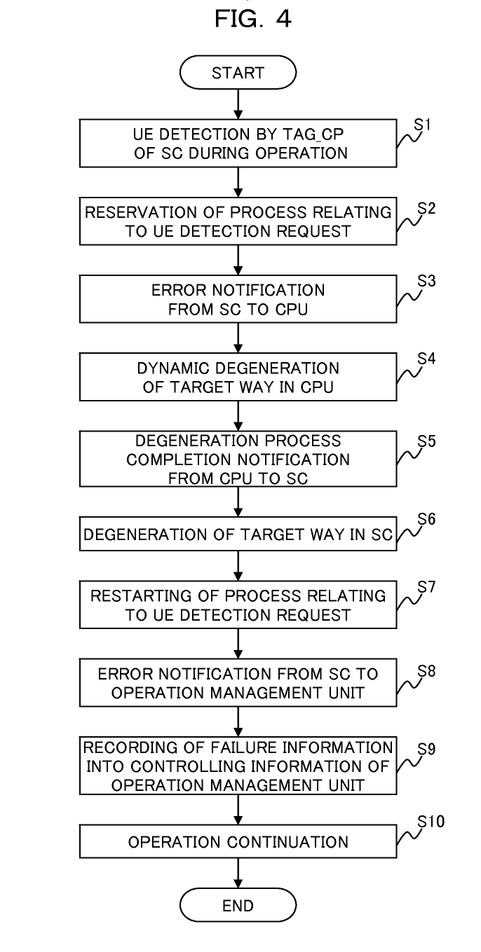

FIG. 3 is a view illustrating a degeneration range when a UE occurs in the TAG_CP memory 42-2 in the SC 4 as an example of the first embodiment, and FIG. 4 is a flow chart illustrating a degeneration process when a UE occurs in the TAG_CP memory 42-2 in the SC 4 as an example of the first embodiment.

First, if a UE is detected in the TAG_CP memory 42-2 during operation of the system as illustrated in FIGS. 3 and 4 (step S1), then a TAG_CP error notification is issued to the request controlling unit 44 by the TAG_CP memory controlling unit 41 in the SC 4.

When the TAG_CP error notification is inputted, a notification of a reservation instruction of the UE detection request is issued to the command controlling unit 43 by the request controlling unit 44 (step S2). The command controlling unit 43 receives the notification of the reservation instruction and retains the UE detection request in a reservation state.

Then, by the request controlling unit 44, a notification of a UE notification request including the index of the suspect location in which the UE is detected and the WAY information is issued to the CPU 3-2 corresponding to the TAG_CP memory 42-2 in which the UE is detected (step S3).

In the CPU 3-2, based on the received UE notification request, all entries of the WAY of the CM 31-2 corresponding to the suspect location are saved into the memory 5 and the degeneration process of the WAY is performed (step S4, refer to “degeneration range” of the TAG memory 32-2 in FIG. 3). In particular, by the CPU 3, a setting changing request for invalidating the WAY corresponding to the suspect location is outputted to the register unit in the CPU 3 and, in the register unit, a degeneration flag is set to the WAY corresponding to the suspect location in the configuration information and the WAY is invalidated. Thereafter, a degeneration process completion notification is issued from the CPU 3-2 to the request controlling unit 44 (step S5).

Further, in the request controlling unit 44, a degeneration process of the WAY corresponding to the suspect location in the SC 4 is performed (step S6, refer to “degeneration range” of the TAG_CP memory 42-2 in FIG. 3). In particular, by the request controlling unit 44, the setting changing request for invalidating the WAY corresponding to the suspect location is outputted to the register unit 46, and, in the register unit 46, the degeneration flag is set to the WAY corresponding to the suspect location in the configuration information and the WAY is invalidated.

It is to be noted that the suspect location is guarded by the address locking register unit 45 so that the suspect location is not referred to based on a different request until the degeneration process of the CPU 3-2 and the TAG_CP memory 42-2 described above is completed. Consequently, multiple occurrences of a UE can be prevented. It is to be noted that, if the degeneration process completion notification is inputted, then, by the address locking register unit 45, the address information relating to the UE detection request retained by the locking register 45a is deleted and the locking of the request is cancelled.

After the degeneration process of the CPU 3-2 and the TAG_CP memory 42-2 described above is completed, by the request controlling unit 44, a notification of an instruction to restart processing of the UE detection request placed in the reservation state is issued to the command controlling unit 43 (step S7). In the command controlling unit 43, the process relating to the UE detection request is restarted based on the received notification of the processing restarting instruction.

Further, by the request controlling unit 44, an interrupt notification of the error information relating to the UE is issued to the operation management unit 6 (step S8).

When the interrupt notification is inputted, by the firmware of the operation management unit 6, information relating to the degenerated WAY is recorded as failure information into the controlling information managed by the operation management unit 6 (step S9).

Then, operation by the information processing system 1 is continued (step S10).

By the processes described above, since the degeneration process of the WAY corresponding to the suspect location is dynamically performed in the CPU 3 and the SC 4, stopping of operation can be avoided also when a UE occurs in the TAG_CP memory 42.

As described above, with the information processing system 1 as an example of the first embodiment, by the request controlling unit 44 of the SC 4, a UE notification request is issued to the CPU 3 when a UE occurs in the TAG_CP memory 42. Then, by the CPU 3, the degeneration process of the WAY corresponding to the WAY in which the UE has occurred is performed based on the received UE notification request. Further, by the request controlling unit 44, the degeneration process of the WAY of the TAG_CP memory 42 in which the UE has occurred is performed.

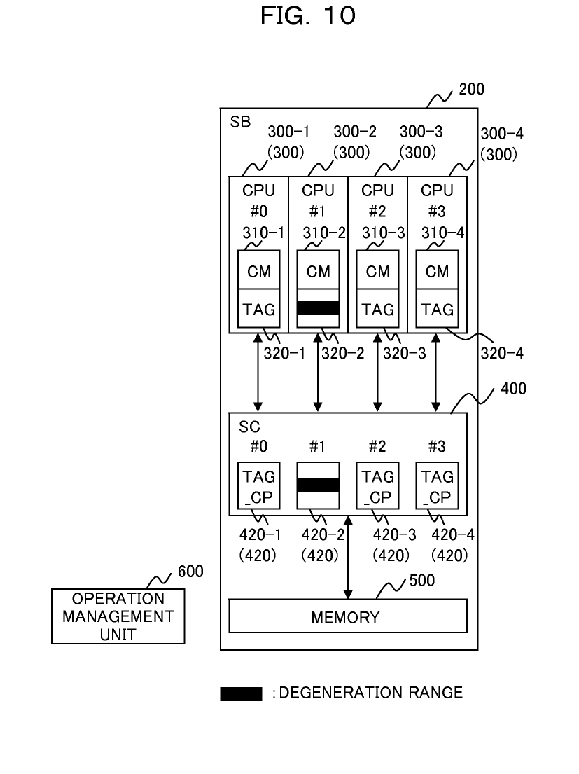

Consequently, similarly as in the case in which a CE occurs in such a TAG_CP memory 420 as exemplified in FIGS. 10 and 11 and so forth described hereinabove, the information processing system 1 can dynamically degenerate the WAY of the TAG memory 32 in the CPU 3 and the WAY of the TAG_CP memory 42 in the SC 4 corresponding to the WAY in which the UE has been detected.

Accordingly, continuous operation of the system is made possible and enhancement of the availability of the information processing system 1 can be implemented.

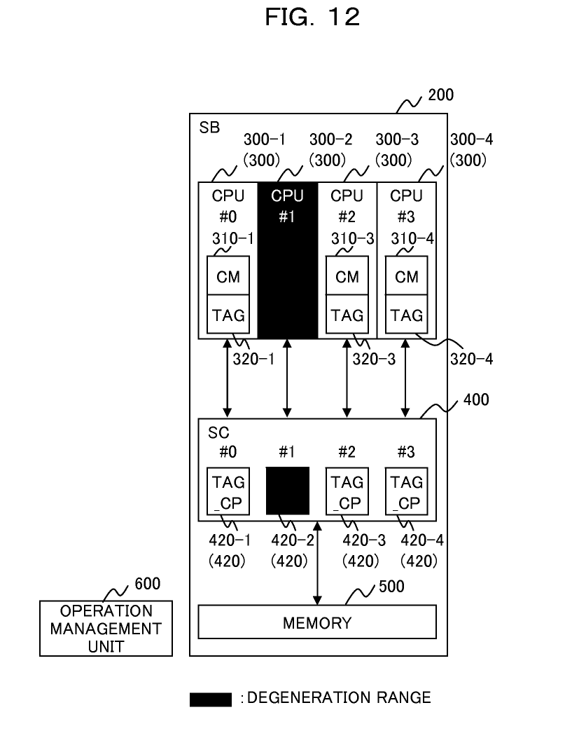

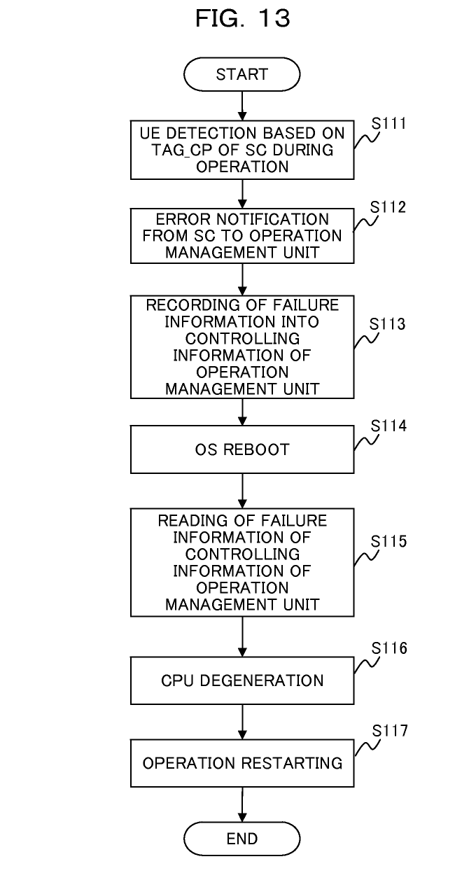

Further, since the degeneration process accompanied by UE detection can be performed in a unit of a WAY, the degeneration range can be limited further in comparison with such a conventional method as exemplified in FIGS. 12 and 13 and so forth described above in which, when a UE occurs, degeneration is performed in a unit of a CPU 300 and in a unit of a TAG_CP memory 420 of the SC 400.

Further, in addition to the degeneration process of the WAY corresponding to the suspect location in the TAG_CP memory 42, also the degeneration process of the WAY corresponding to the suspect location in the TAG memory 32 of the CPU 3 is performed.

Accordingly, since a request from the CPU 3 to the suspect location is not issued after the degeneration process completion on the CPU 3 side, the processing load upon the CPU 3 can be suppressed and significant degradation of the performance of the information processing system 1 when a UE occurs can be suppressed.

Further, the TAG_CP memories 42-1 to 42-4 correspond in a one-by-one corresponding relationship to the TAG memories 32-1 to 32-4 in the CPU 3-1 to 3-4. Accordingly, even if part (WAY) of the TAG_CP memory 42 is degenerated, the CPU 3 can perform access to a different CPU 3 other than the CPU 3 corresponding to the suspect location. Therefore, performance degradation arising from retry of request issuance from the CPU 3 can be prevented.

Further, with the information processing system 1 as an example of the first embodiment, by the request controlling unit 44 of the SC 4, an instruction for causing the command controlling unit 43 to re-issue the UE detection request is performed after the degeneration process completion notification of the TAG memory 32 is received from the CPU 3.

Consequently, since the UE detection request is re-issued by the command controlling unit 43 after completion of the degeneration process, retry of the UE detection request that has not been processed in the request destination may be omissible in the CPU 3 that has issued the UE detection request.

Accordingly, the processing load upon the CPU 3 involved in the degeneration process relating to the UE detection request can be suppressed and degradation of the performance of the information processing system 1 when a UE occurs can be suppressed.

Further, with the information processing system 1 as an example of the first embodiment, by the address locking register unit 45, access to the suspect location based on a different request is inhibited until the WAY corresponding to the suspect location is degenerated in the CPU 3 and the SC 4.

Consequently, the UE detection request and such a request which has not been performed in the request source such as a later request to the suspect location are re-issued by the command controlling unit 43.

Accordingly, the suspect location can be guarded so that cache tag data in which the UE has been detected is not referred to based on a different request, and the cache coherency can be maintained. In particular, since such OS restarting for degeneration of the CPU 3 itself corresponding to the TAG_CP memory 42 in which a UE has occurred as exemplified in FIG. 13 described hereinabove may be omissible, continuous operation of the system is made possible and enhancement of the availability of the information processing system 1 can be implemented.

Further, guarding of the UE occurrence suspect location by the address locking register unit 45 is implemented utilizing the guarding function for guarding so that a later request does not compete with the request during processing.

Further, with the information processing system 1 as an example of the first embodiment, when the address of the UE detection request is retained in the locking register 45a by the address locking register unit 45, also a region having an index same as that of the suspect location is guarded when the indexes coincide with each other while the full addresses do not coincide with each other. It is to be noted that, in this case, the address locking register unit 45 is configured such that the bit width for address comparison can be varied.

Consequently, reference to the region having the index same as that of the suspect location of the TAG_CP memory 42 based on the later request during degeneration processing after a UE occurs can be inhibited.

Accordingly, by adding a case of coincidence of a full address or an index in the actual address in the UE detection request to a condition for retry of a later request by the guarding function of the address locking register unit 45 described above, guarding of the suspect location can be implemented and provision of a new circuit may be omissible. Therefore, the fabrication and maintenance cost for the information processing system 1 can be reduced.

Further, with the information processing system 1 as an example of the first embodiment, the degeneration flag indicating degeneration of a WAY of the TAG_CP memory 42 is retained by the register unit 46.

Consequently, in comparison with an alternative configuration in which the degeneration flag is provided in the TAG_CP memory 42, for example, also when a failure occurs in an address line system, the request controlling unit 44 can perform setting of the degeneration flag with certainty and can perform the degeneration process of the UE with certainty.

### [2] Second Embodiment

### [2-1] Configuration of the Second Embodiment

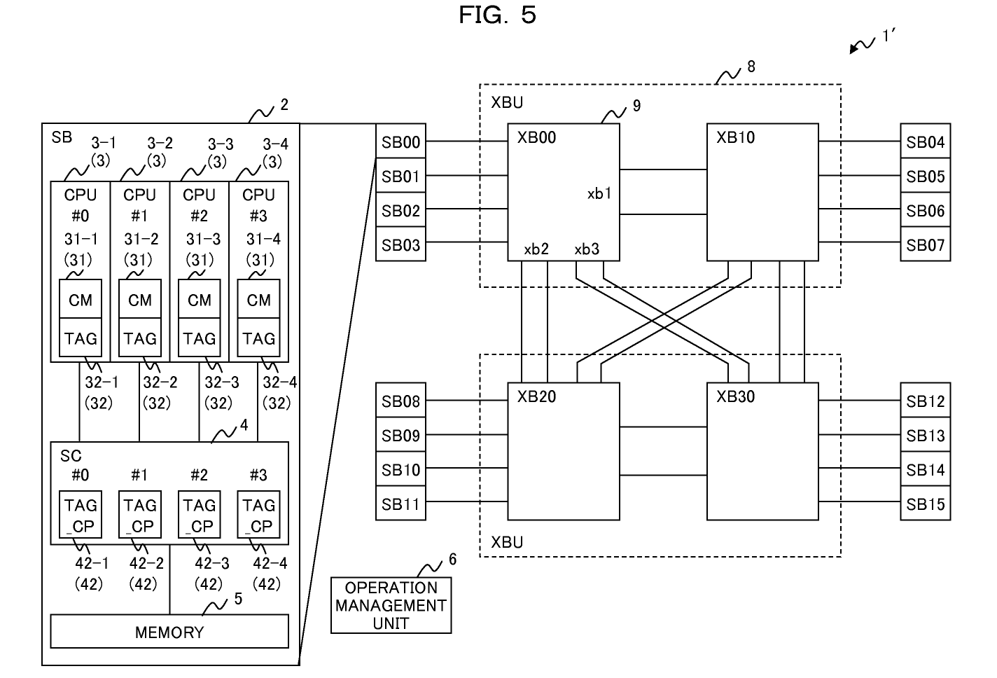

Now, a configuration of an information processing system (information processing apparatus) 1′ as a second embodiment is described with reference to FIGS. 5 to 9. It is to be noted that, since like or substantially like elements to those in FIG. 5 are denoted by like reference characters, overlapping description of them is omitted.

FIG. 5 is a view depicting the information processing system 1′ as an example of the second embodiment.

As depicted in FIG. 5, the information processing system 1′ in the second embodiment includes a plurality of (16 in the example depicted in FIG. 5) SBs 2, an operation management unit 6 and a plurality of (four in the example depicted in FIG. 5) cross bars (each hereinafter referred to as XB) 9.

The information processing system 1′ functions as an SMP server system for which all or part of the plurality of SBs 2 are used.

The XB 9 is an LSI having a data transfer function between the plurality of SBs 2 and is mounted in a cross bar unit (depicted as XBU in FIG. 5) 8.

The operation management unit 6 has a configuration similar to that of the first embodiment and incorporates firmware for controlling the entire information processing system 1′, namely, CPUs 3 and an SC 4 in each SB 2, therein. Further, the operation management unit 6 retains information of the CPU 3 and WAY information degenerated by each SB 2 as failure information in controlling information managed by the operation management unit 6.

Further, the information processing system 1′ may include a storage unit (not illustrated) to which the SC 4 in each SB 2 can access similarly as in the first embodiment.

Similarly as in the first embodiment, the SC 4 in the second embodiment can execute a process relating to a request issued from the CPU 3 in the own SB 2. Further, the SC 4 in the second embodiment includes an interface function for the communication between the plurality of SBs 2 and can execute, when a request to the own SB 2 is issued through the XB 9 by the CPU 3 in a different SB 2, a process relating to the request.

It is to be noted that, in the second embodiment, a case is exemplified in which a cache line of the CM 31 has 256 bytes and the number of WAYs is 12.

A configuration of the TAG_CP memory 42 in the second embodiment is described below.

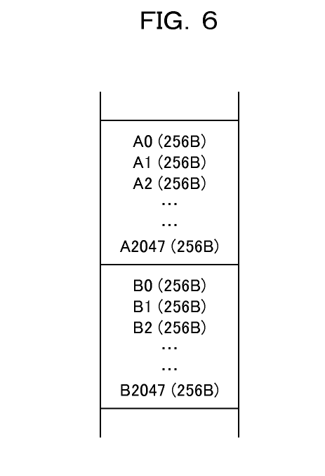

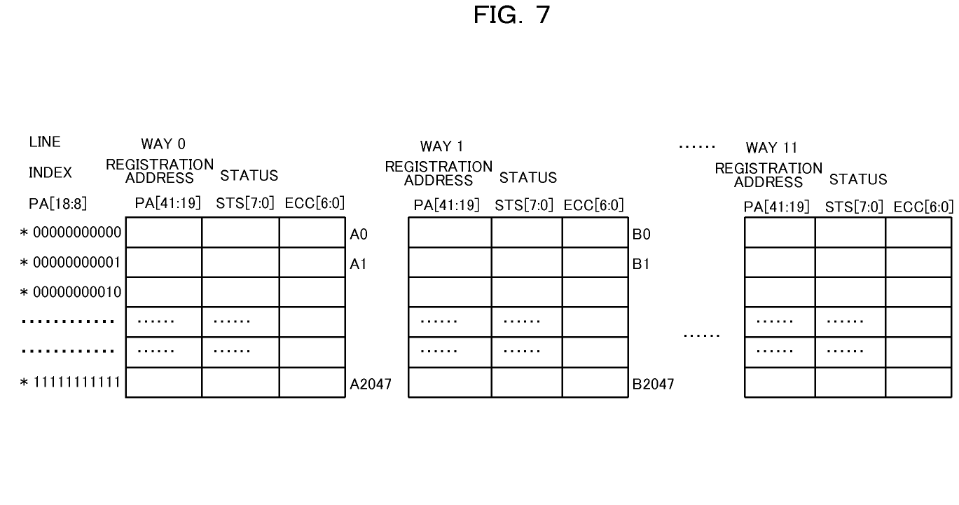

FIG. 6 is a view illustrating an address map of the memory 5 as an example of the second embodiment and FIG. 7 is a view depicting a configuration of the TAG_CP memory 42 as an example of the second embodiment. It is to be noted that, in the example depicted in FIG. 7, one row in a table of each WAY corresponds to one cache tag data.

As depicted in FIG. 6, the memory 5 in the second embodiment is managed by the SC 4 in a unit (block) of a cache line (256 bytes).

The TAG_CP memory 42 in the SC 4 in the second embodiment manages the cache tag data in the form illustrated in FIG. 7.

In particular, in the TAG_CP memory 42, 41:19 bits from within the actual address (PA) of the memory 5 are stored as a registration address of the cache tag data.

Further, in the TAG_CP memory 42, 7:0 bits of the status (STS) of a cache are stored in the cache tag data.

Further, in the TAG_CP memory 42, an error correction code (ECC) of the cache tag data is added as data of 7 bits to the cache tag data.

Further, an index that is part of an actual address of the memory 5 is used for an address of the TAG_CP memory 42 for storing the registration address and the status described above therein.

It is to be noted that, in the second embodiment, a case is exemplified in which the index indicating the cache line has 11 bits and the number of cache lines is 2048. In particular, in the example depicted in FIG. 7, 18:8 bits from within the actual address of the memory 5 are allocated to the index address.

Accordingly, in the address map of the memory 5 depicted in FIG. 6, blocks having the same index (for example, A0 and B0) are allocated to the same index address as depicted in FIG. 7. Further, the blocks having the same index are stored in order into a WAY 0, a WAY 1, . . . and a WAY 11.

It is to be noted that the status in the cache tag data is represented, for example, by 4 states in the MOSI protocol. The MOSI protocol is a protocol which adopts four cache statuses of M (Modified), O (Owned), S (Shared) and I (Invalid).

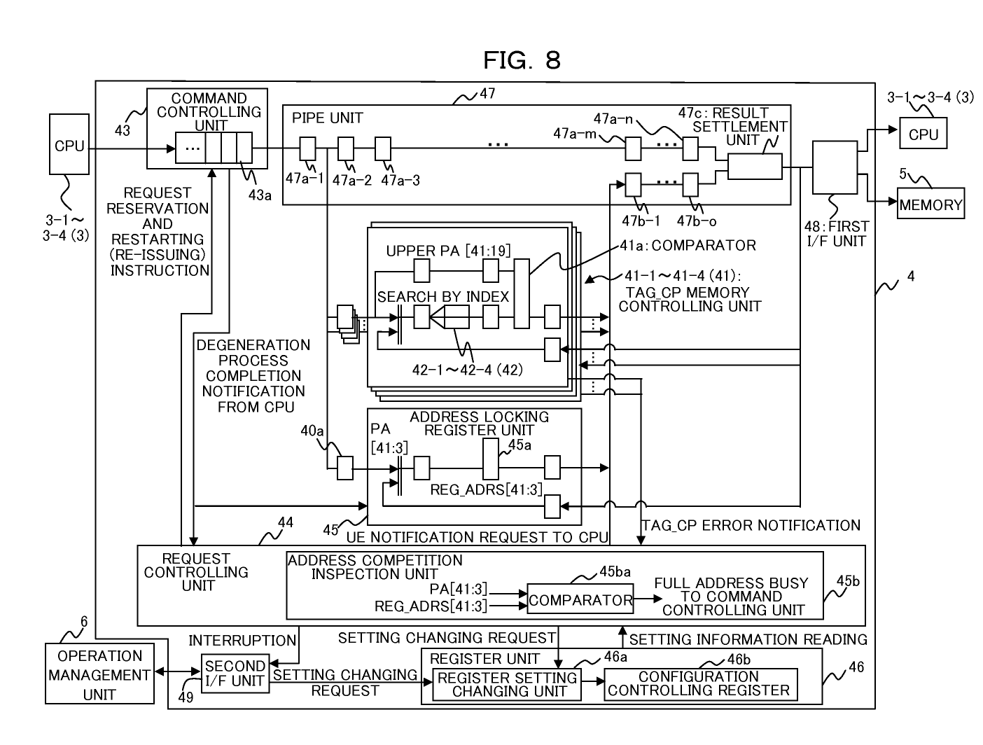

Further, the SC 4 performs, when a CE or a UE is detected in the TAG_CP memory 42, operation similar to that in the first embodiment, and an example of a more particular configuration of the SC 4 is described with reference to FIG. 8. It is to be noted that, since like or substantially like elements to those in FIG. 8 are denoted by like reference characters, overlapping description of them is omitted.

FIG. 8 is a view depicting a configuration of the SC 4 as an example of the second embodiment.

The SC 4 exemplified in FIG. 8 includes a pipe unit 47, a first interface (I/F) unit 48 and a second I/F unit 49 in addition to the components of the SC 4 in the first embodiment.

Further, in the SC 4 exemplified in FIG. 8, the TAG_CP memory controlling unit 41 includes a comparator 41a; the request controlling unit 44 includes an address competition inspection unit 45b; and the register unit 46 includes a register setting changing unit 46a and a configuration controlling register 46b, in addition to those of the SC 4 in the first embodiment.

Further, the command controlling unit 43 in the SC 4 exemplified in FIG. 8 includes a queue 43a for retaining requests received from the CPU 3 and performs control for transferring the requests in the queue 43a in order to the pipe unit 47 and transferring the requests in order to the TAG_CP memory controlling unit 41 and the address locking register unit 45 through the pipe unit 47. Further, the command controlling unit 43 retains a transferred request until a process relating to the transferred request is completed. Further, if an instruction for re-issuing (retrying) a retained request is received, then the command controlling unit 43 registers the request relating to the instruction for the re-issuing into the queue 43a again and performs re-issuing.

As depicted in FIG. 8, the pipe unit 47 includes a plurality of latch circuits 47a-1 to 47a-n and 47b-1 to 47b-o (m, n and o in FIG. 8 each indicates a number of provided latch circuits; it is to be noted that m<n), and a result settlement unit 47c.

The pipe unit 47 inputs a request from the command controlling unit 43 to the latch circuit 47a-1 and outputs the request from the latch circuit 47a-1 to the latch circuit 47a-2, TAG_CP memory controlling units 41 and address locking register unit 45.

The request inputted to the latch circuit 47a-2 passes through the latch circuits 47a-2 to 47a-n in order and then is outputted to the result settlement unit 47c in order to meet with a searching process in the TAG_CP memory controlling unit 41.

On the other hand, the request inputted to the TAG_CP memory controlling unit 41 and the address locking register unit 45 is subjected to a searching process by the TAG_CP memory controlling unit 41 and outputted as a cache search result to the latch circuit 47b-1. The cache search result passes through the latch circuits 47b-1 to 47b-o in order and then is outputted to the result settlement unit 47c.

The result settlement unit 47c settles a transfer destination of the request based on the request having passed through the latch circuits 47a-1 to 47a-n and the cache search result having passed through the latch circuits 47b-1 to 47b-o and then outputs a result of the settlement to the first I/F unit 48.

The first I/F unit 48 transmits the request outputted from the result settlement unit 47c of the pipe unit 47 to the transfer destination settled by the result settlement unit 47c, for example, to the CPU 3 or the memory 5 in the own SB 2, the SC 4 in a different SB 2 through the XBs 9 or the like.

It is to be noted that, while, in the example depicted in FIG. 8, the first I/F unit 48 transmits the request to the CPU 3 or the memory 5, the function may be divided into units like, for example, a CPU I/F unit and a memory I/F unit.

Here, the latch circuits 47a-1 to 47a-n and 47b-1 to 47b-o and a latch circuit 40a hereinafter described are each configured, for example, from a flip-flop. By the latch circuits 47a-1 to 47a-n and 47b-1 to 47b-o, the timings at which the request and the cache search result are inputted to the result settlement unit 47c are adjusted.

When the request from the command controlling unit 43 is inputted, then the TAG_CP memory controlling units 41-1 to 41-4 extract an index and a registration address from an actual address of the memory 5 included in the request similarly as in the first embodiment. Then, the TAG_CP memory controlling units 41-1 to 41-4 search cache tag data corresponding to the extracted index and registration address from within the TAG_CP memories 42-1 to 42-4.

It is to be noted that, in the second embodiment, the index has 18:8 bits from within the actual address of the memory 5 and the registration address has 41:19 bits from within the actual address of the memory 5 as described above.

In particular, as depicted in FIG. 8, based on the index extracted from the request, the TAG_CP memory controlling unit 41 extracts a registration address having the same index from the TAG_CP memory 42. Then, the TAG_CP memory controlling unit 41 compares the registration address (refer to upper PA [41:19] in FIG. 8) extracted from the request and the registration address extracted from the TAG_CP memory 42 using the comparator 41a to decide whether or not the registration addresses coincide with each other.

If the registration addresses coincide with each other, namely, if the cache tag data relating to the request hits in the TAG_CP memory 42, then the TAG_CP memory controlling unit 41 refers to the cache tag data in which the coincident registration address extracted from the TAG_CP memory 42 is included.

It is to be noted that, when the cache tag data relating to the request hits or does not hit in the TAG_CP memory 42 by the search, the contents of later processes are determined in response to the contents of the request and the status of the cache tag data. Since the determination of the contents of the processes can be implemented by various known methods, detailed description of the methods is omitted here.

The request controlling unit 44 performs operation similar to that in the first embodiment.

It is to be noted that, in the example depicted in FIG. 8, when a UE occurs in the TAG_CP memory 42, the request controlling unit 44 issues a notification of a setting changing request to the register setting changing unit 46a in order to perform a degeneration process of a WAY of the TAG_CP memory 42 in which the UE has occurred.

The register setting changing unit 46a performs setting of a degeneration flag based on the setting changing request to the configuration controlling register 46b in which configuration information is retained.

Further, when a UE occurs, the request controlling unit 44 issues an interrupt notification of error information to the second I/F unit 49 including the interface function between the SC 4 and the operation management unit 6. When the interrupt notification is received, the second I/F unit 49 issues the received interrupt notification to the operation management unit 6.

Further, for example, when a CE or a UE occurs, the SC 4 may perform degeneration of the TAG_CP memory 42 in which the CE or the UE has occurred and the corresponding CPU 3 itself if the number of WAYs operating in the TAG_CP memory 42 in which the CE or the UE has occurred is equal to or lower than a predetermined number (for example, 1).

In particular, if a CE or a UE occurs in the TAG_CP memory 42 and the number of operating WAYs of the TAG_CP memory 42 in which the CE or the UE has occurred is equal to or smaller than the predetermined number, then if the degeneration process of the WAYs in which the CE or the UE has occurred is performed, then a WAY that operates in the TAG_CP memory 42 disappears. Therefore, in the second embodiment, when the number of operating WAYs of the TAG_CP memory 42 in which a CE or a UE has occurred is equal to or lower than the predetermined number, the request controlling unit 44 degenerates the entire TAG_CP memory 42 in which the CE or the UE has occurred and degenerates the CPU 3 itself corresponding to the TAG_CP memory 42.

It is to be noted that the degeneration process in this case can be performed by the method exemplified in FIG. 13 given above. Further, when a CE or a UE occurs, the request controlling unit 44 can grasp the number of WAYs operating in the TAG_CP memory 42 in which the CE or the UE has occurred by reading in the setting information of the degeneration flag set in the configuration controlling register 46b or the like.

Further, the request controlling unit 44 may count the number of times of occurrence of a CE and issue a notification of the CE detection request to the CPU 3 when the number of times of occurrence of a CE is equal to or greater than a predetermined threshold value.

For example, if the degeneration state in the CPU 3 and the SC 4 is reset by restarting of the OS during execution in the information processing system 1′, then the operation management unit 6 degenerates the WAY corresponding to the suspect location again based on the failure information stored in the operation management unit 6. At this time, the operation management unit 6 issues a notification of the setting changing request based on the failure information to the register setting changing unit 46a through the second I/F unit 59.

Similarly as in the case of the setting changing request from the request controlling unit 44, the register setting changing unit 46a performs setting of a degeneration flag based on the setting changing request to the configuration controlling register 46b in which the configuration information is retained.

It is to be noted that also the CPU 3 in the second embodiment includes a configuration controlling register (not illustrated) and the operation management unit 6 can perform setting changing also for the configuration controlling register provided in the CPU 3.

When the request is inputted from the command controlling unit 43, similarly as in the first embodiment, the address locking register unit 45 retains address information in the received request into the locking register 45a.

In particular, as depicted in FIG. 8, the address locking register unit 45 extracts an index and a full address (for example, 41:3 bits in the second embodiment) from the actual address in the request transferred from the command controlling unit 43 and then retains the extracted full address into the locking register 45a.

The address locking register unit 45 further includes an address competition inspection unit 45b for comparing the full address in the actual address in the request during processing and the full address in the actual address in the request retained in the locking register 45a with each other.

It is to be noted that, while the address competition inspection unit 45b in the example depicted in FIG. 8 is provided in the request controlling unit 44, it is connected to the address locking register unit 45 and operates as a function of the address locking register unit 45. It is to be noted that the address competition inspection unit 45b may be provided otherwise in the address locking register unit 45.

The address competition inspection unit 45b includes a comparator 45ba, and the full address in the actual address in a later request is inputted from the latch circuit 40a to a PA [41:3] of the comparator 45ba at a timing at which the full address is inputted to the latch circuit 40a. Further, the full address in the actual address in the request retained in the locking register 45a (REG_ADRS [41:3] in the address locking register unit 45 in FIG. 8) is inputted from the locking register 45a to the REG_ADRS [41:3] of the comparator 45ba.

Then, if it is decided by the comparator 45ba in the address competition inspection unit 45b that the two inputted full addresses coincide with each other, then the comparator 45ba issues a notification that the full address relating to the later address is in a busy state (full address busy) to the command controlling unit 43.

In this manner, similarly as in the first embodiment, the address locking register unit 45 in the second embodiment includes a guarding function for cancelling and retrying the process relating to the later request transferred from the command controlling unit 43 to guard to prevent competition with the request during processing.

Further, similarly as in the first embodiment, if a UE occurs, then the address locking register unit 45 retains, in addition to the process described above, the full address of the suspect location in the UE detection request in the locking register 45a until the degeneration process of the suspect location by the CPU 3 and the SC 4 is completed.

Consequently, when the full address (PA [41:3]) relating to the later request and the full address (REG_ADRS [41:3]) of the suspect location in the UE detection request coincide with each other, the address competition inspection unit 45b issues a notification of full address busy of the later request to the command controlling unit 43 similarly as in the first embodiment.

In particular, the address locking register unit 45 inhibits access to the TAG_CP memory 42 in which the UE has occurred based on a different request until it receives the degeneration process completion notification of the TAG memory 32 from the CPU 3 and the request controlling unit 44 degenerates the WAY of the TAG_CP memory 42 in which the UE has occurred.

In this manner, similarly as in the first embodiment, the address locking register unit 45 in the second embodiment can use the guarding function to guard the process relating to the later request so that competition with the request during processing is prevented and guard the suspect location when a UE occurs.

It is to be noted that, in the example depicted in FIG. 8, a line for status updating is provided from between the result settlement unit 47c of the pipe unit 47 and the first I/F unit 48 to each TAG_CP memory controlling unit 41 and the address locking register unit 45. Consequently, at a stage at which the request is outputted from the result settlement unit 47c, updating of the status in each TAG_CP memory controlling unit 41 and control of locking in the address locking register unit 45 are performed.

In particular, when a UE occurs, the address locking register unit 45 can receive information indicating maintenance of the locking from the result settlement unit 47c through the line for status updating and maintain the locking relating to the UE detection request in the locking register 45a.

### [2-2] Operation Upon Occurrence of a CE or a UE by the Information Processing System of the Second Embodiment

Now, a degeneration process when a CE or a UE occurs in a TAG_CP memory 42 of the SC 4 in the information processing system 1′ configured in such a manner as described above is described.

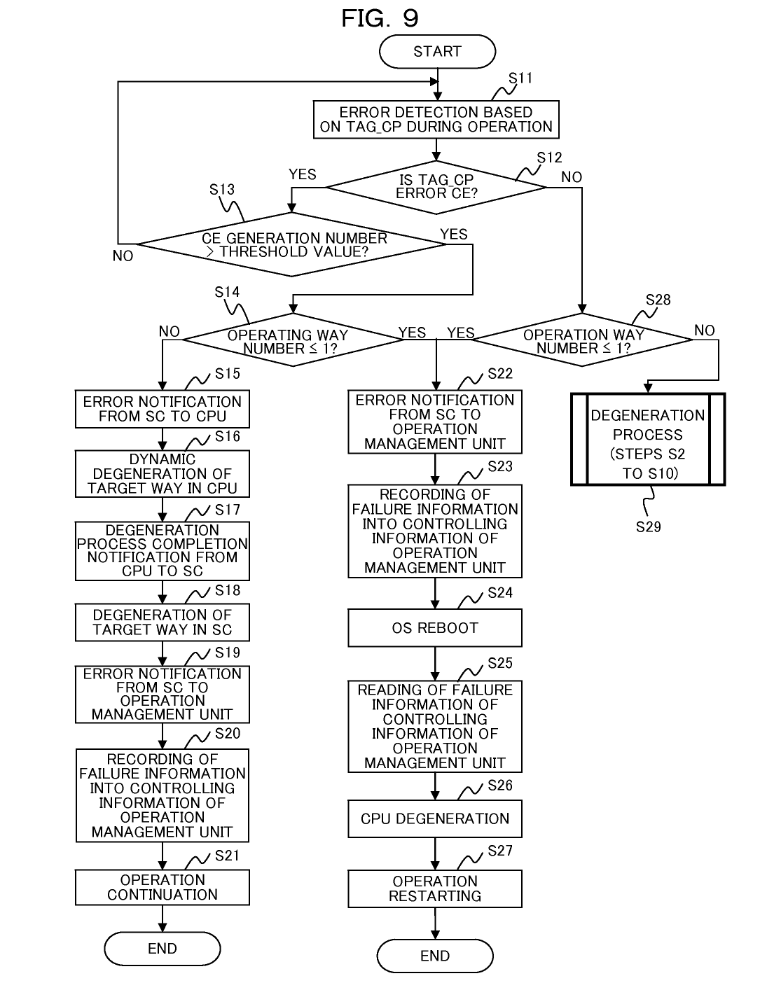

FIG. 9 is a flow chart illustrating a degeneration process when a CE or a UE occurs in the TAG_CP memory 42-2 in the SC 4 as an example of the second embodiment.

First, if, during operation of the system, an error occurs in the TAG_CP memory 42-2 and is detected by the TAG_CP memory controlling unit 41-2 as illustrated in FIG. 9 (step S11), then it is decided by the SC 4 whether or not the detected error is a CE (step S12).

If it is decided that the detected error is a CE (Yes route at step S12), then it is decided by the request controlling unit 44 whether or not the number of occurring CEs is greater than the predetermined threshold value (step S13).

If it is decided that the number of occurring CEs is equal to or smaller than the predetermined threshold value (No route at step S13), then the request controlling unit 44 increments the value of a counter for counting the number of occurring CEs and returns the processing to operation of the information processing system 1′.

On the other hand, if it is decided that the number of occurring CEs is greater than the predetermined threshold value (Yes route at step S13), then it is decided by the request controlling unit 44 whether or not the number of WAYs operating in the TAG_CP memory 42-2 in which the CE has occurred is equal to or smaller than a predetermined number (here, 1) (step S14).

If it is decided that the number of operating WAYs is greater than 1 (No route at step S14), then a notification of the CE notification request is issued from the request controlling unit 44 to the CPU 3-2 corresponding to the TAG_CP memory 42-2 in which the CE has occurred (step S15). It is to be noted that the request includes an index of the suspect location corrected by an ECC and the WAY information.

In the CPU 3, based on the notification of the information of the suspect location, cache data of the WAY in the TAG memory 32-2 in which the CE has occurred is delivered to the memory and the degeneration process is performed for the WAY of the TAG memory 32-2 in which the CE has occurred (step S16). Then, by the CPU 3-2, a notification of degeneration process completion is issued to the SC 4 (step S17).

In the request controlling unit 44 that receives the degeneration process completion notification, the degeneration process is performed for the WAY of the TAG_CP memory 42-2 in which the CE has occurred (step S18). Then, by the request controlling unit 44, a notification of error information relating to the CE is issued to the operation management unit 6 (step S19) and failure information is recorded into the controlling information of the operation management unit 6 (step S20). Thereafter, in the information processing system 1′, operation is continued (step S21).

On the other hand, if it is decided at step S14 by the request controlling unit 44 that the number of operating WAYs is equal to or smaller than 1 (Yes route at step S14), then a notification that a CE has occurred and the degeneration process of the CPU 3-2 is performed is issued as interrupt from the request controlling unit 44 to the operation management unit 6 (step S22).

After the interrupt notification, in the operation management unit 6, information indicating the CPU 3-2 having the TAG memory 32 corresponding to the TAG_CP memory 42-2 that is the suspect target and the WAY information are recorded as failure information into the controlling information controlled by the operation management unit 6 itself (step S23). Then, by the operation management unit 6, the OS during execution in the information processing system 1′ is restarted (step S24).

After the restarting of the OS, the failure information of the controlling information is read in by the operation management unit 6 (step S25), and the starting process is not performed for the CPU 3-2 recorded in the failure information but is performed only for the other normal CPUs 3-1, 3-3 and 3-4. In other words, the degeneration process is performed for the CPU 3-2 corresponding to the suspect location by the operation management unit 6 (step S26). Thereafter, in the information processing system 1′, the operation is restarted (step S27).

On the other hand, if it is decided at step S12 that the detected error is not a CE, namely, the detected error is a UE (No route at step S12), then it is decided by the request controlling unit 44 whether or not the number of WAYs operating in the TAG_CP memory 42-2 in which the UE has occurred is equal to or smaller than the predetermined number (here, 1) (step S28).

If it is decided that the number of operating WAYS is greater than 1 (No route at step S28), then the processes at steps S2 to S10 described above with reference to FIG. 4 are performed (step S29).

In particular, a TAG_CP error notification is issued from the TAG_CP memory controlling unit 41 to the request controlling unit 44, and, by the request controlling unit 44, a notification of a reservation instruction of the UE detection request is issued to the command controlling unit 43 (step S2). Then, the UE detection request is retained as a reservation state into the command controlling unit 43.

Then, by the request controlling unit 44, a notification of the UE detection request is issued to the CPU 3-2 corresponding to the TAG_CP memory 42-2 in which the UE has occurred (step S3).

In the CPU 3-2, the degeneration process of the WAY of the CM 31-2 corresponding to the suspect location is performed (step S4), and a degeneration process completion notification is issued to the request controlling unit 44 (step S5).

Further, by the request controlling unit 44, the degeneration process of the WAY corresponding to the suspect location is performed in the SC 4 (step S6).

After the degeneration process completion notification is issued from the CPU 3-2 and the degeneration process of the WAY of the TAG_CP memory 42-2 in which the UE has occurred is completed, by the request controlling unit 44, a notification of an instruction for processing restarting of the UE detection request is issued to the command controlling unit 43 (step S7). In the command controlling unit 43, the process relating to the UE detection request is restarted (re-issued).

Then, an interrupt notification of the error information relating to the UE is issued to the operation management unit 6 by the request controlling unit 44 (step S8).

When the interrupt notification is inputted, by the firmware of the operation management unit 6, the information relating to the degenerated WAY is stored as failure information into the controlling information managed by the operation management unit 6 (step S9). Then, the operation by the information processing system 1′ is continued (step S10).

On the other hand, if it is decided at step S28 by the request controlling unit 44 that the number of operating WAYs is equal to or smaller than 1 (Yes route at step S28), then an interrupt notification that a UE has occurred and the degeneration process of the CPU 3-2 is performed is issued from the request controlling unit 44 to the operation management unit 6 (step S22). Thereafter, the processes at steps beginning with step S23 described above are performed for the CPU 3-2 corresponding to the TAG_CP memory 42 in which the UE has occurred.

In this manner, with the information processing system 1′ (particularly, the SC 4) as the second embodiment, effects similar to those of the first embodiment described above can be achieved.

Further, with the information processing system 1′ as an example of the second embodiment, the occurrence number of times of a CE is counted by the request controlling unit 44, and when the occurrence number of times of a CE is greater than the predetermined threshold value, a notification of the CE detection request is issued to the CPU 3.

Consequently, when the occurrence number of times of a CE is equal to or smaller than the predetermined threshold value, since the degeneration process of the WAY is not performed, performance degradation of the information processing system 1′ arising from the degeneration process of the WAY can be suppressed.

### [3] Others

While the preferred embodiments of the present invention and the modifications thereto are described in detail above, the present invention is not limited to the embodiments and the modifications specifically described above, and various modifications and alterations can be made without departing from the scope of the present invention.

For example, while the configuration in which the number of CPUs 3 in the SB 2 is four is described above in connection with the first and second embodiments, the number of CPUs 3 is not limited to this and one or a different number of CPUs 3 may be provided. Whichever number of CPUs 3 are provided, the TAG_CP memory 42 corresponding to each TAG memory 32 (CPU 3) may be provided in the SC 4.

Further, while, in the first and second embodiments described above, a process is reserved relating to a request in which a UE is detected until the degeneration process of the target WAY in the CPU 3 and the SC 4 is completed, the present invention is not limited to this. For example, when a UE is detected, if it can be confirmed from the cache tag data that there is the latest data in a different CPU 3, namely, in a CPU 3 different from the CPU 3 corresponding to the TAG_CP memory 42 in which the UE has been detected, then the process may be performed normally for the UE detection request. It is to be noted that, when there is the latest data in the different CPU 3, the status of the cache tag data of the TAG_CP memory 42 of a different WAY with respect to a request in which a UE has been detected is indicated, for example, in the MOSI protocol, by “M” or “O”.

For example, relating to the UE detection request, the process for removing address locking is performed in the procedure of a normal process, namely, the process is performed normally for the UE detection request, and the process for deleting an address from the locking register 45a after completion of the process is inhibited. Then, after the discharging process of data of the CM 31 involved in the degeneration process of the CPU 3 is completed, the process for removing the address locking is performed. Therefore, it is preferable to add information indicating that the status relating to the request indicates “M” or “O” to the address retained in the locking register 45a or the data passing through the pipe unit 47.

Or, it may be permitted that a UE occurs by a plural number of times until the data discharging process of the CM 31 involved in the degeneration process of the CPU 3 is completed.

As described above, when the CPU 3 corresponding to the TAG_CP memory 42 in which a UE has occurred is different from the CPU 3 that is a request source of the UE detection request and the CPU 3 that retains the latest data are different from one another, processing delay by reservation of the UE detection request can be prevented.

Further, the processes at steps S22 to S27 from the Yes route at step S14 in the flow chart depicted in FIG. 9 in the second embodiment described above, namely, the processes when a CE occurs in the TAG_CP memory 42 and the number of WAYs operating in the TAG_CP memory 42 in which the CE has occurred is equal to or smaller than the predetermined number, are not limited to them. For example, the information processing system 1′ may continue the operation without executing the processes at steps S22 to S27.

Further, the processes at steps S22 to S27 from the Yes route at step S28 in the flow chart depicted in FIG. 9 in the second embodiment described above, namely, the processes when a CE occurs in the TAG_CP memory 42 and the number of WAYs operating in the TAG_CP memory 42 in which the CE has occurred is equal to or smaller than the predetermined number, are not limited to them. For example, in the information processing system 1′, the processes at steps S22 to S27 may be omissible, but a notification that a UE has occurred in the last WAY may be issued from the SC 4 to the OS and, in the OS, the ending (shutdown) process may be performed after all of the processes during execution are ended.

Further, the process at step S6 in the flow chart depicted in FIG. 4 in the first and second embodiments may be performed before or within the processes at steps S3 to S5. In particular, the degeneration process of the WAY of the TAG_CP memory 42 in which a UE has occurred by the request controlling unit 44 may be performed before or in parallel to the degeneration process of the WAY of the CPU 3 corresponding to the WAY.

With the technique of the present disclosure, enhancement of the availability of the information processing apparatus can be implemented.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing apparatus, comprising:
an arithmetic processing unit including a cache memory and a first tag memory; and
a system controller that performs communication control between the arithmetic processing unit and a different processing apparatus; wherein
the system controller includes:
a command controlling unit that retains a request received from the arithmetic processing unit and re-issues the request when the request is not processed in a requesting destination;
a second tag memory that retains replicated data of data stored in the first tag memory; and
a request controlling unit that issues, when an uncorrectable error (UE) occurs in data read out from the second tag memory, a notification of WAY information of the second tag memory in which the UE has occurred to the arithmetic processing unit, wherein
the arithmetic processing unit degenerates, when the notification of the occurrence of the UE is received from the request controlling unit, a WAY of the first tag memory corresponding to the WAY of the second tag memory in which the UE has occurred and then issues a notification that a degeneration process of the WAY of the first tag memory is completed to the request controlling unit; and
the request controlling unit degenerates, when the UE occurs, the WAY of the second tag memory in which the UE has occurred, and receives the notification that the degeneration process of the first tag memory is completed from the arithmetic processing unit and then issues an instruction for causing the command controlling unit to re-issue a request relating to the UE.

2. The information processing apparatus according to claim 1, wherein, when the UE occurs, the request controlling unit issues an instruction for causing the command controlling unit to reserve the request relating to the UE.

3. The information processing apparatus according to claim 1, wherein the system controller includes an address locking register that inhibits, when the UE occurs, access in accordance with a different request to the data in which the UE has occurred of the second tag memory, until the notification that the degeneration process of the first tag memory is completed from the arithmetic processing unit is received and the WAY of the second tag memory in which the UE has occurred is degenerated.

4. The information processing apparatus according to claim 3, wherein the address locking register includes a locking register that retains address information in a request; and
extracts, when the UE occurs, address information in the request relating to the UE and causes the locking register to retain the extracted address information, and issues, when address information in a later request with respect to the request relating to the UE coincides with the address information, retained in the locking register, in the request relating to the UE, an instruction for causing the command controlling unit to re-issue the later request.

5. The information processing apparatus according to claim 1, wherein the system controller includes a register unit that retains a degeneration flag indicating that the WAY of the second tag memory being degenerated; and
the request controlling unit sets a degeneration flag relating to the WAY of the second tag memory in which the UE has occurred to the register unit to degenerate the WAY in which the UE has occurred of the second tag memory.

6. The information processing apparatus according to claim 1, wherein the information processing apparatus includes a plurality of arithmetic processing units individually including the cache memory and the first tag memory; and
the system controller includes a plurality of second tag memories corresponding to the plurality of first tag memories provided in the plurality of arithmetic processing unit.

7. The information processing apparatus according to claim 1, wherein the information processing apparatus includes an operation management unit that performs control relating to the information processing apparatus;
the request controlling unit degenerates the WAY of the second tag memory in which the UE has occurred and then issues a notification of error information relating to the UE to the operation management unit; and
the operation management unit retains information relating to the degenerated WAY based on the notification from the request controlling unit and degenerates, when an operating system (OS) to be executed by the information processing apparatus is restarted, the WAYS of the first and second tag memories based on the retained information relating to the degenerated WAY.

8. The information processing apparatus according to claim 7, wherein, when the number of WAYs that are operating when the UE occurs in the second tag memory is equal to or smaller than a predetermined number, the request controlling unit issues a notification of information indicating an arithmetic processing unit including the first tag memory corresponding to the WAY of the second tag memory, in which the UE has occurred, to the operating management unit; and
the operation management unit retains the information indicating the arithmetic processing unit indicated in the notification from the request controlling unit and restarts the OS to be executed by the information processing apparatus and then degenerates the arithmetic processing unit based on the retained information indicating the arithmetic processing unit.

9. The information processing apparatus according to claim 7, wherein, when a correctable error (CE) occurs in the data read out from the second tag memory, the request controlling unit issues a notification of information of the WAY of the second tag memory in which the CE has occurred to the arithmetic processing unit;
when the notification that the CE has occurred is received from the request controlling unit, the arithmetic processing unit degenerates the WAY of the first tag memory corresponding to the WAY of the second tag memory in which the CE has occurred and issues a notification that the degeneration process of the WAY of the first tag memory is completed to the request controlling unit; and
the request controlling unit degenerates, when the CE occurs, the WAY of the second tag memory in which the CE has occurred.

10. The information processing apparatus according to claim 9, wherein, when the number of WAYs that are operating when the CE occurs in the second tag memory is equal to or smaller than a predetermined number, the request controlling unit issues a notification of information indicating an arithmetic processing unit that includes the first tag memory corresponding to the WAY of the second tag memory in which the CE has occurred to the operation management unit; and
the operation management unit retains the information indicating the arithmetic processing unit indicated in the notification from the request controlling unit, and restarts the OS to be executed by the information processing apparatus and degenerates the arithmetic processing unit based on the retained information indicating the arithmetic processing unit.

11. A cache controlling method for an information processing apparatus including an arithmetic processing unit including a cache memory and a first tag memory, and a system controller that performs communication control between the arithmetic processing unit and a different processing apparatus, the method comprising:
issuing, by the system controller, when an uncorrectable error (UE) occurs in data read out from a second tag memory that retains replicated data of data stored in the first tag memory, a notification of WAY information of the second tag memory in which the UE has occurred to the arithmetic processing unit;
degenerating, by the arithmetic processing unit, when the notification of the occurrence of the UE is received, a WAY of the first tag memory corresponding to the WAY of the second tag memory in which the UE has occurred and then is suing a notification that a degeneration process of the WAY of the first tag memory is completed to the system controller; and
degenerating, by the system controller, the WAY of the second tag memory in which the UE has occurred and receiving a notification that the degeneration process of the first tag memory is completed, from the arithmetic processing unit, and then re-issuing a request relating to the UE.

12. The cache controlling method according to claim 11, further comprising:
reserving, by the system controller, when the UE occurs in the data read out from the second tag memory, the request relating to the UE.

13. The cache controlling method according to claim 11, further comprising:
inhibiting, by the system controller, access in accordance with a different request to the data in which the UE has occurred of the second tag memory, until the notification that the degeneration process of the first tag memory is completed from the arithmetic processing unit is received and the WAY of the second tag memory in which the UE has occurred is degenerated.

14. The cache controlling method according to claim 13, further comprising:
extracting, by the system controller, when the UE occurs, address information in the request relating to the UE and retaining the extracted address information, and then re-issuing, when address information in a later request with respect to the request relating to the UE coincides with the address information in the request relating to the retained UE, the later request.

15. The cache controlling method according to claim 11, further comprising:
setting, by the system controller, when the UE occurs, a degeneration flag indicating that the WAY of the second tag memory in which the UE has occurred being degenerated to a register unit provided in the system controller to degenerate the WAY in which the UE has occurred of the second tag memory.

16. The cache controlling method according to claim 11, wherein the information processing apparatus includes the plurality of arithmetic processing units individually including the cache memory and the first tag memory; and
the system controller includes the plurality of second tag memories corresponding to the plurality of first tag memories included in the plurality of arithmetic processing units.

17. The cache controlling method according to claim 11, wherein the information processing apparatus includes an operation management unit that performs control relating to the information processing apparatus;
the method further comprising:
degenerating, by the system controller, the WAY of the second tag memory in which the UE has occurred and then issuing a notification of error information relating to the UE to the operation management unit; and
retaining, by the operation management unit, information relating to the degenerated WAY based on the notification from the system controller and degenerating, when an Operating System (OS) to be executed by the information processing apparatus is restarted, the WAYs of the first and second tag memories based on the information relating to the retained degenerated WAY.

18. The cache controlling method according to claim 17, further comprising:
issuing, by the system controller, when the number of WAYs that are operating when the UE occurs in the second tag memory is equal to or smaller than a predetermined number, a notification of information indicating an arithmetic processing unit including the first tag memory corresponding to the WAY of the second tag memory in which the UE has occurred to the operation management unit; and
retaining, by the operation management unit, the information indicating the arithmetic processing unit indicated in the notification from the system controller and restarting the OS to be executed in the information processing apparatus and then degenerating the arithmetic processing unit based on the retained information indicating the arithmetic processing unit.

19. The cache controlling method according to claim 17, further comprising:
issuing, by the system controller, when a Correctable Error (CE) occurs in data read out from the second tag memory, the notification of the WAY information of the second tag memory in which the CE has occurred to the arithmetic processing unit;
degenerating, by the arithmetic processing unit, when the notification that the CE has occurred is received from the system controller, the WAY of the first tag memory corresponding to the WAY of the second tag memory in which the CE has occurred and issuing a notification that the degeneration process of the WAY of the first tag memory is completed to the system controller; and
degenerating, by the system controller, when the CE occurs, the WAY of the second tag memory in which the CE has occurred.

20. The cache controlling method according to claim 19, further comprising:
issuing, by the system controller, when the number of WAYs that are operating when the CE occurs in the second tag memory is equal to or smaller than a predetermined number, a notification of information indicating an arithmetic processing unit including the first tag memory corresponding to the WAY of the second tag memory in which the CE has occurred to the operation management unit; and
retaining, by the operation management unit, the information indicating the arithmetic processing unit indicated in the notification from the system controller and restarting the OS to be executed by the information processing apparatus and then degenerating the arithmetic processing unit based on the retained information indicating the arithmetic processing unit.
